(19) United States
(12) Patent Application Publication
(10) Pub. No.: US 2022/0156797 A1
(43) Pub. Date: May 19, 2022

(54) METHODS, DEVICES, AND SYSTEMS FOR PROVIDING PERSONALIZED IMMERSIVE CONTENT IN EXTENDED REALITY (XR) ENVIRONMENTS

(71) Applicant: AT&T Intellectual Property I, L.P., Atlanta, GA (US)

(72) Inventors: Jean-Francois Paiement, Sausalito, CA (US); David Crawford Gibbon, Lincroft, NJ (US); Eric Zavesky, Austin, TX (US)

(73) Assignee: AT&T Intellectual Property I, L.P., Atlanta, GA (US)

(21) Appl. No.: 17/099,991

(22) Filed: Nov. 17, 2020

(51) Int. Cl. G06Q 30/02; G06N 20/00; G06T 19/00

(52) U.S. Cl. CPC G06Q 30/0271; G06N 20/00; G06Q 30/0275; G06T 19/003; G06Q 30/0267

(57) ABSTRACT

Aspects of the subject disclosure may include, for example, obtaining data relating to a user, where the data relating to the user includes user profile data regarding user activities in a first domain, mapping the user profile data to a second domain, resulting in mapped user profile data, receiving, from an immersion engine, data regarding an immersion environment, obtaining data relating to advertisement content, where the data relating to advertisement content includes information identifying an advertisement object, deriving immersive advertising data based on the mapped user profile data, the data regarding the immersion environment, and the data relating to the advertisement content, and outputting the immersive advertising data to the immersion engine, where the immersive advertising data enables the immersion engine to embed the advertisement object in the immersion environment. Other embodiments are disclosed.

### FIELD OF THE DISCLOSURE

The subject disclosure relates to providing personalized immersive content (e.g., immersive advertising) in extended reality (XR) environments.

### BACKGROUND

Immersion environments provided via XR (e.g., augmented reality (AR) systems, virtual reality (VR) systems, mixed reality (MR) systems, etc.) are becoming targets for advertising.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communication network in accordance with various aspects described herein.

FIG. 2A is a block diagram illustrating an example, non-limiting embodiment of a system functioning in, or in conjunction with, the communication network of FIG. 1 in accordance with various aspects described herein.

FIG. 2B is a block diagram illustrating an example, non-limiting embodiment of a system functioning in, or in conjunction with, the communication network of FIG. 1 and/or the system of FIG. 2A in accordance with various aspects described herein.

FIG. 2C is a diagram illustrating an example progression of immersive advertising enabled by the communication network of FIG. 1, the system of FIG. 2A, and/or the system of FIG. 2B in accordance with various aspects described herein.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

Immersion environments, provided via XR (e.g., AR, VR, MR, etc.), offer advertising opportunities that are unavailable in traditional two-dimensional (2D) digital domains, such as a web sites, smartphone apps, etc. However, the wealth of available data on user activities and/or preferences in the digital domain (e.g., relating to Internet browsing, video or other content consumption, purchase histories, and/or the like) can be leveraged for immersive advertising in the XR realm. Additionally, user activities within an immersion environment, such as interactions with objects in the environment (e.g., gazing at an object, touching an object, avoiding an object, vocal utterances, etc.), which may be indicative of user preferences, can also be leveraged for immersive advertising.

The subject disclosure describes, among other things, illustrative embodiments for an immersive advertising platform that is capable of personalizing, or optimizing, immersive advertising for users in immersion environments based on user profile data (e.g., including data relating to user activities and/or preferences in the digital domain, data relating to user behavior in immersion environments, and/or the like), data relating to an immersion environment, data relating advertisement content (e.g., including information identifying candidate advertisement objects for inclusion in an immersion environment), or a combination thereof.

In various embodiments, the immersive advertising platform is capable of personalizing, or optimizing, the immersive advertising in a manner that balances the needs of advertisers, characteristics of an immersion environment, as well as user tolerance for advertisements (e.g., for purposes of providing immersive advertising that is minimally obtrusive to users), by identifying advertisement content (e.g., inventories of advertisement content) as well as parameters for presenting corresponding advertisement objects (e.g., a virtual version of a product, a branded logo, and/or the like) in an immersion environment based on user profile data (e.g., concerning a particular user, a particular category of users, or users in general), advertiser editorial preferences relating to advertisement appearance (e.g., whether the advertisement object is an image, an audio clip, a video clip, an interactive object, etc.) and/or object form (e.g., what the model of an advertisement object is, whether the advertisement object should be static, etc.), and data regarding a context and/or content of the immersion environment. For example, the immersive advertising platform can be capable of determining an optimal location for presenting an advertisement object in an immersion environment, an optimal proximity of an advertisement object relative to a user, an optimal frequency for presenting the advertisement object in the immersion environment, and/or the like.

In various embodiments, the immersive advertising platform can include, or be implemented in, one or more machine learning models (or algorithms) that are trainable and configured to dynamically provide optimized advertising inventory outputs in real-time, or near real-time, based on various inputs, such as the aforementioned user profile data, advertiser preferences, data relating to immersion environment(s), and/or the like.

In various embodiments, the immersive advertising platform is capable of performing domain adaptation by mapping, or otherwise translating, user profile data from the digital domain (e.g., Interactive Advertising Business (IAB)-related data, tag data, genre data, embedding data, and/or the like) into object affinity in XR (e.g., immersion environment attributes, numerical features, and/or the like) as well as by mapping, or otherwise translating, data relating to user interactions and/or activities within immersion environment(s) into digital preferences (e.g., user profile data, which may involve semantic meanings, numerical scores, and/or the like).

Embodiments of the immersive advertising platform, as described herein, enable seamless adaptation of traditional ad tech systems for use in the XR realm. Dynamic and automated identification or creation of immersive advertising inventories (e.g., advertisement objects, placement locations thereof, and/or contexts for such placements) that are consistent with target immersion environment(s), based on digital domain data (e.g., historical user preferences and/or the like) available in traditional ad tech systems, also enhances the reach of such ad tech systems. This also simplifies immersive advertising development and management for advertisers, for example, where an advertiser can simply provide options for ad exposure, such as an image, a video clip, an object model, etc., and defer to the immersive advertising platform to determine manners of presenting advertisement(s) for optimal continuity or consistency with a user's immersion environment experience. This further enhances immersive branding capabilities of advertisers (e.g., where an advertiser can leverage the immersive advertising platform to experiment with different advertisement objects in a given immersion environment context to determine an optimal immersive advertising strategy).

One or more aspects of the subject disclosure include a device, comprising a processing system including a processor, and a memory that stores executable instructions that, when executed by the processing system, facilitate performance of operations. The operations can include obtaining data relating to a user, where the data relating to the user includes user profile data regarding user activities in a first domain. Further, the operations can include mapping the user profile data to a second domain, resulting in mapped user profile data, receiving, from an immersion engine, data regarding an immersion environment, and obtaining data relating to advertisement content, where the data relating to advertisement content includes information identifying an advertisement object. Further, the operations can include deriving immersive advertising data based on the mapped user profile data, the data regarding the immersion environment, and the data relating to the advertisement content, and outputting the immersive advertising data to the immersion engine, where the immersive advertising data enables the immersion engine to embed the advertisement object in the immersion environment.

One or more aspects of the subject disclosure include a non-transitory machine-readable medium, comprising executable instructions that, when executed by a processing system including a processor, facilitate performance of operations. The operations can include receiving, from an immersive advertising platform, data relating to a user and data regarding an immersion environment. Further, the operations can include providing, to the immersive advertising platform and responsive to the receiving the data relating to the user and the data regarding the immersion environment, data relating to advertisement content, where the data relating to advertisement content includes information identifying an advertisement object and bid information, and where the information identifying the advertisement object and the bid information enable the immersive advertising platform to derive immersive advertising data capable of causing an immersion engine to embed the advertisement object in the immersion environment. Further, the operations can include obtaining, from the immersive advertising platform, feedback regarding a behavior of the user relative to the advertisement object, and modifying the data relating to the advertisement content based on the feedback, resulting in modified data, where the modified data is usable to cause the immersive advertising platform to derive different immersive advertising data for the user in the immersion environment or in a different immersion environment.

One or more aspects of the subject disclosure include a method. The method can comprise providing, by a processing system including a processor, and to an immersive advertising platform, data regarding an immersion environment, where the data regarding the immersion environment includes information identifying a plurality of locations in the immersion environment that is available for placement of an advertisement, and where the data regarding the immersion environment enables the immersive advertising platform to derive immersive advertising data for advertisement embedding into the immersion environment. Further, the method can include obtaining, by the processing system, from the immersive advertising platform and responsive to the providing the data regarding the immersion environment to the immersive advertising platform, the immersive advertising data, where the immersive advertising data identifies an advertisement object and identifies a location of the plurality of locations in the immersion environment at which the advertisement object is to be positioned. Further, the method can include presenting, by the processing system, the advertisement object at the location of the plurality of locations in the immersion environment responsive to the obtaining the immersive advertising data from the immersive advertising platform, detecting, by the processing system, an interaction, by a user, with the advertisement object at the location of the plurality of locations in the immersion environment, and causing, by the processing system, data regarding the interaction to be transmitted to the immersive advertising platform responsive to the detecting the interaction.

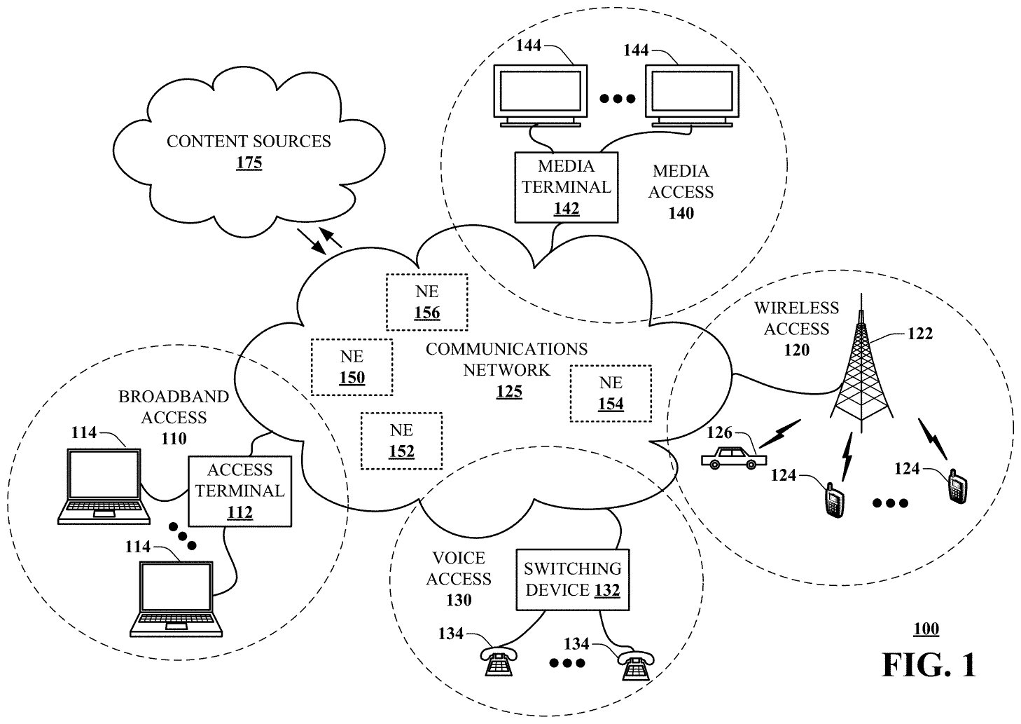

Referring now to FIG. 1, a block diagram is shown illustrating an example, non-limiting embodiment of a communication network or system 100 in accordance with various aspects described herein. For example, system 100 can facilitate in whole or in part personalization, or optimization, of immersive advertising in an immersion environment based on user profile data (e.g., including data relating to user activities and/or preferences in the digital domain, data relating to user behavior within immersion environment(s), and/or the like), data relating to an immersion environment, and/or data relating advertisement content (e.g., information identifying candidate advertisement objects for inclusion in the immersion environment). In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

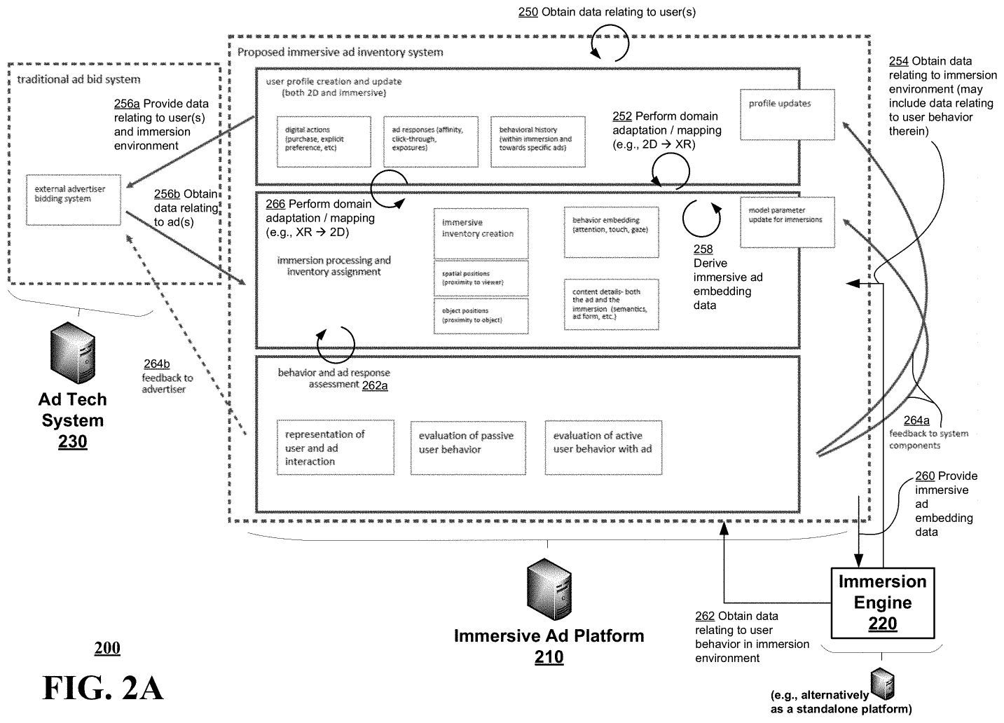

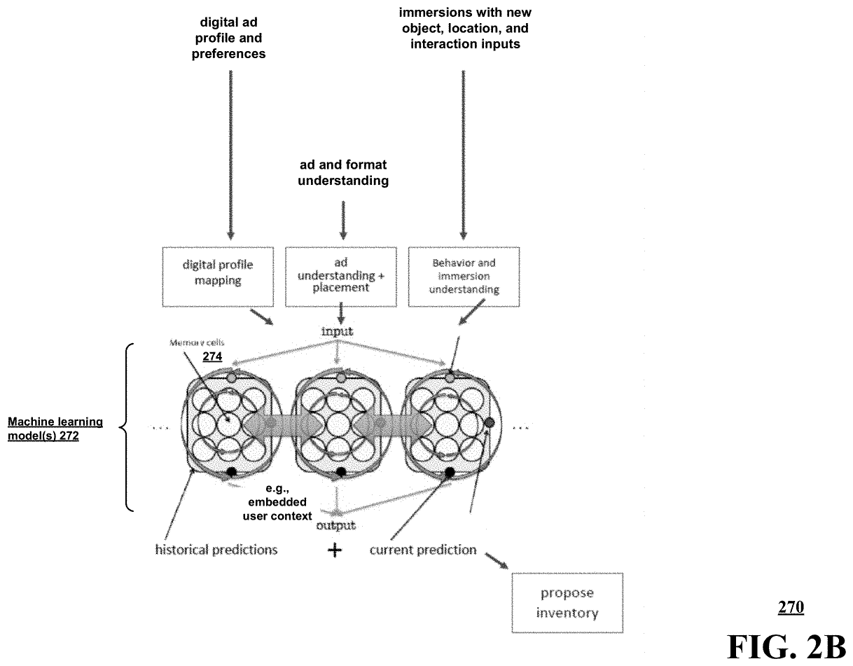

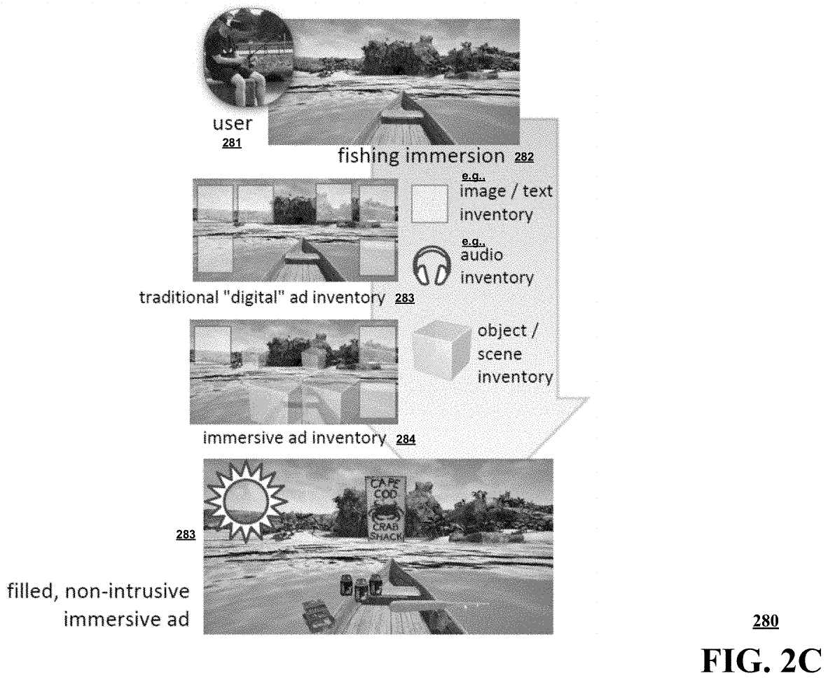

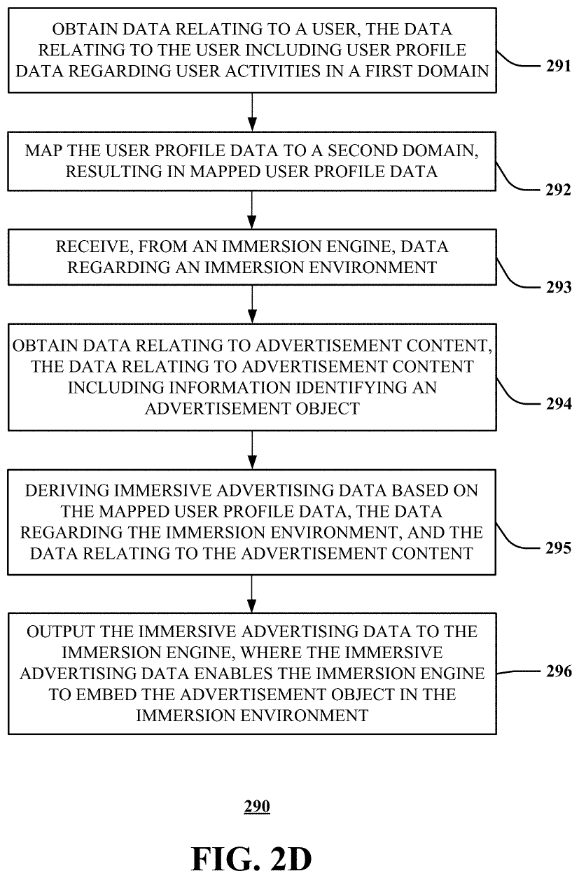

FIG. 2A is a block diagram illustrating an example, non-limiting embodiment of a system 200 functioning in, or in conjunction with, the communication network of FIG. 1 in accordance with various aspects described herein. In various embodiments, the system 200 can be capable of personalizing, or optimizing, immersive advertising in XR, including by identifying and/or creating optimal advertisement inventories to be presented in immersion environments, based on user profile data, data relating to advertisement content, data relating to immersion environment(s), or a combination thereof.

As shown in FIG. 2A, the system 200 can include an immersive advertising platform 210. The immersive advertising platform 210 can include one or more devices (e.g., server device(s) or the like) configured to provide one or more functions or capabilities, such as determination, personalization, and/or optimization of advertisement inventories for immersion environments, as described herein.

As shown in FIG. 2A, the immersive advertising platform 210 can be communicatively coupled to an immersion engine 220 and an ad tech system 230. The ad tech system 230 can include one or more devices (e.g., server device(s) or the like) configured to provide one or more advertising-related functions or capabilities, such as device management, traffic management, campaign management and/or analytics, system and data integration, sales, billing, and data management, advertising bidding management, and/or the like. The immersion engine 220 that can include one or more devices (e.g., server device(s), head-mounted display device(s), heads-up display device(s), goggle(s), or other wearable device(s)) configured to provide one or more functions or capabilities relating to providing and/or managing an immersion environment, user device management, and/or the like.

In various embodiments, the immersive advertising platform 210 can include, or otherwise be implemented, in one or more machine learning models. In some embodiments, the immersive advertising platform 210 can be configured to implement transfer learning—e.g., domain adaptation—by leveraging existing labeled data in the 2D digital domain, such as user profile data available from an ad marketplace. As shown by reference number 250, for example, the immersive advertising platform 210 can obtain user profile data as input. In various embodiments, the user profile data can include data that is specific to individual users, data that is specific to categories or groups of users, data generally relating to all users, or a combination thereof. In various embodiments, the user profile data can include, or be represented as, numbers, mathematical vectors, and/or the like suitable, for example, to be used as inputs for domain adaptation by machine learning model(s) of the immersive advertising platform 210.

In various embodiments, the user profile data can include 2D digital domain data, such as data relating to user preferences (e.g., historical explicit preferences, including advertisement placement policy restrictions, opt-in or opt-out preferences, or the like), data relating to user behaviors and/or interests (e.g., historical behaviors, such as Internet browsing activities, video or other content consumption, purchase histories, and/or the like), data relating to advertisement responses (e.g., advertisement exposures, click-through actions, affinities between users and advertisements and/or advertisement types), and/or other data representative or indicative of user activities, preferences, and/or behaviors (e.g., IAB-related data, tag data, genre data, embedding data, and/or the like).

In various embodiments, the user profile data can include XR domain data, such as data relating to user behavior in immersion environments (e.g., user activities or interactions associated with objects in immersion environments, including objects that are native to the immersion environment and/or advertisement objects included, or embedded, in the immersion environment by the immersive advertising platform 210, e.g., as described in more detail below).

As shown by reference number 252, the immersive advertising platform 210 can perform domain adaptation by mapping the user profile data, as input parameters, to corresponding object-related features in the XR domain, as output parameters. In various embodiments, object-related features can include numerical values, mathematical vectors, and/or the like that represent affinity (e.g., an affinity between a user and an advertisement object, an affinity between a user and an object of the immersion environment, and/or the like). Leveraging, or otherwise reusing, user profile data available in the digital domain enables the immersive advertising platform 210 to derive constructs on which decisions can be made to optimize or improve immersive advertising for users in immersion environments.

In various embodiments, the immersive advertising platform 210 can additionally, or alternatively, obtain data relating to immersion environment(s). As shown by reference number 254, for example, the immersive advertising platform 210 can obtain, from the immersion engine 220, data relating to immersion environment(s). The data can include, for example, information relating to physical dimensions of an immersion environment, surfaces of the immersion environment, objects native to or included within the immersion environment, characteristics or parameters associated with such surfaces and/or objects, advertisement placement availability with respect to such surfaces and/or objects, actions that users can perform with respect to such surfaces and/or objects, contextual information regarding the immersion environment (e.g., regarding a theme of the immersion experience, such as activities associated with the immersion environment (e.g., car driving, fishing, etc.) or the like), or a combination thereof.

As shown by reference number 256a, the immersive advertising platform 210 can provide user profile data and/or data relating to an immersion environment to the ad tech system 230. In some embodiments, the immersive advertising platform 210 can provide a portion of the user profile data that is relevant to a user or users currently experiencing an immersion environment, in which advertisers may desire to present advertisement objects. In some embodiments, the immersive advertising platform 210 can alternatively provide all of the user profile data to the ad tech system 230.

As shown by reference number 256b, the immersive advertising platform 210 can obtain, from the ad tech system 230, data relating to advertisement content. In various embodiments, the immersive advertising platform 210 can obtain the data from the ad tech system 230 responsive to the immersive advertising platform 210 providing the user profile data and/or the data relating to an immersion environment, as described above with respect to reference number 256a. In some embodiments, the data relating to the advertisement content can include information identifying advertisement object(s) (e.g., an image, text, an audio clip, a video clip, etc.). In some embodiments, the data relating to advertisement content can include bid information, such as a bid price (e.g., a maximum price) for each advertisement object. In some embodiments, the data relating to the advertisement content can include information regarding the advertisement object(s), such as physical dimensions of the advertisement object(s), visibility information for the advertisement object(s) (e.g., brightness information, contrast information, and/or other information on how prominent an advertisement object may be presented, etc.), spatial location or placement information for the advertisement object(s) (e.g., a minimum or a maximum distance between where an advertisement object may be placed relative to another object in an immersion environment), a classification or category of the advertisement object(s), context data for the advertisement object(s) (e.g., identifying immersion environment contexts for which the advertisement object(s) may be suitable and/or the like), text font type, style, and/or size requirements, audio volume requirements, video quality requirements, graphics information or requirements (e.g., image and/or video quality requirements, image and/or video color requirements, etc.), manipulation or control information for the advertisement object(s) (e.g., identifying degrees of rotation or orienting of an advertisement object, ability to raise an advertisement object, ability to carry, or otherwise transport, an advertisement object about in the immersion environment, ability to use the advertisement object as part of an immersion experience (e.g., a branded model of a fishing pole in a fishing-related immersion environment in addition to, or as a substitute for, an existing or native fishing pole in the immersion environment, where the branded fishing pole model may be associated with a side mission of the fishing immersion experience), etc.), or a combination thereof.

In various embodiments, the immersive advertising platform 210 can provide, to the ad tech system 230, affinity information, such as affinity scores or the like (described in more detail below), based on the data relating to advertisement content obtained from the ad tech system 230, the user profile data, and/or the data relating to an immersion environment. An affinity score can represent a propensity of a user to interact with, engage with, or otherwise favorably receive, an advertisement object. This can inform an advertiser (or an agent thereof) on whether to bid a higher price to present an advertisement object to a particular user that is likely to show interest in the advertisement object, and to bid a lower price (or not bid at all) if the particular user is likely to show minimal or no interest in the advertisement object. For example, responsive to receiving affinity information from the immersive advertising platform 210, an advertiser (or an agent thereof) can submit, via the ad tech system 230, bid information, or updated bid information, for one or more advertisement objects to the immersive advertising platform 210. In one or more embodiments, the ad tech system 230 (e.g., a bidding system thereof) can include various platforms (e.g., a real-time auction(s)) where line-items or pre-determined requirements, are utilized, such as in conjunction with the affinity information, to facilitate delivery of advertising. These line-items can be manually determined, automatically suggested, or fully automated in creation and execution within the ad tech system 230. In another embodiment, for additional analysis speed and in deference to users of the ad tech system 230 (e.g., bidders), data provided to the ad tech system 230 in step 256a may include only user profile data, only immersion-related data, all data except affinity/propensity scores, or any combination thereof.

As shown by reference number 258, the immersive advertising platform 210 can derive, or otherwise determine, immersive advertising data (e.g., immersive advertising embedding data). The immersive advertising embedding data can include vector information and/or the like concerning advertisement object(s) to be embedded (e.g., by the immersion engine 220) within an immersion environment. In various embodiments, the immersive advertising embedding data can specify an optimal advertisement object (e.g., by type or category) for embedding into an immersion environment, across multiple modalities, such as audio objects, video objects, three-dimensional objects, etc. In some embodiments, the immersive advertising platform 210 can generate, create, or otherwise adapt from a model (e.g., an aggregate model represented by vectors), embedding features of advertisement object(s) for presenting the advertisement object(s) within an immersion environment. In various embodiments, the immersive advertising platform 210 can generate or create, and train, a model, such as an embedding/understanding model represented by vectors, that associates individual user behaviors or actions with respective numerical responses (e.g., that may or may not be specific to objects). The immersive advertising platform 210 can utilize this model to derive immersive advertising embedding data for the user and update the model based on data relating to the user's behavior in immersion environment(s).

In various embodiments, the immersive advertising platform 210 can determine the immersive advertising embedding data based on the above-described user profile data, data relating to advertisement content, data relating to an immersion environment, data relating to user activities and/or interactions in the immersion environment (e.g., information on a user's current gaze, a user's current interactions with environment objects (e.g., touching or the like), etc. obtained from the immersion engine 220, as described below with respect to reference number 262), or a combination thereof. In various embodiments, the immersive advertising platform 210 can derive the immersive advertising embedding data by performing (e.g., via one or more iterations of trained machine learning model(s)) a variety of analyses and/or operations associated with some or all of the foregoing data. In some embodiments, the immersive advertising platform 210 can derive immersive advertising embedding data that specifies placement of an advertisement object based on some or all of the foregoing data. For example, in a case where users have historically reacted negatively towards a certain advertisement content (e.g., departing from the immersion environment after observing and/or interacting with the advertisement content), or in a case where a large quantity of advertisements has been presented (or is being presented) within an immersion environment, the immersive advertising platform 210 can derive immersive advertising embedding data such that advertisement object(s) are placed within an immersion environment in a less pervasive manner (e.g., at lower quantities, farther away from certain objects within the immersion environment, shown less prominently relative to objects within the immersion environment, spaced farther apart from one another within the immersion environment, and/or the like). This can lessen the impact of advertisements on the quality of experience of users in an immersion environment, or otherwise mitigate user aversion to immersive advertising.

In various embodiments, the analyses and/or operations can include determining, based on data relating to an immersion environment, candidate regions within the immersion environment for advertisement placement. For example, in a case where the data relating to an immersion environment includes information regarding available surfaces of the immersion environment for advertisement placement, objects that are native to or included within the immersion environment, characteristics or parameters associated with such surfaces and/or objects, contextual information regarding the immersion environment, and/or the like, the immersive advertising platform 210 can derive immersive advertising embedding data that specifies placement of an advertisement object on a particular surface of the immersion environment and proximate to a particular object within the immersion environment, based on the information.

In various embodiments, the analyses and/or operations can include determining advertisement objects for inclusion in an immersion environment based on data relating to historical user interactions with objects, including advertisement objects, within immersion environment(s). In various embodiments, the analyses and/or operations can place different emphasis on, or associate different weights with, historical user behavior depending on the recency of such behavior, and derive immersive advertising embedding data based on the weights. For example, the immersive advertising platform 210 can associate a higher weight with recent data (e.g., in the past few minutes, in the past few days, etc.) relating to a particular user behavior with respect to a certain type of object, associate a lower weight with prior data (e.g., months ago, years ago, etc.) relating to the same or similar user behavior, and derive immersive advertising embedding data using the recent data and not the prior data (or using the prior data to a lesser extent than the recent data). As another example, the immersive advertising platform 20 can associate a higher weight with data, relating to a particular user behavior with respect to a certain type of object, that spans a longer time period (e.g., over the past 5 years, 10 years, etc.) than with recent data (e.g., just a few seconds ago, just a few minutes ago, etc.) relating to the same or similar user behavior, and derive immersive advertising embedding data using the data spanning the longer time period and not the recent data (or using the recent data to a lesser extent than the data spanning the longer time period).

In various embodiments, the analyses and/or operations can include assessing a density of activity within an immersion environment, determining available locations therein in which advertisement object(s) can be placed, determining a size of an advertisement object (e.g., whether to apply small form fitting for advertisement objects so as to achieve volume boosting in a noisy environment with numerous objects), determining a frequency of presenting an advertisement object, determining a duration for presenting an advertisement object, and/or the like. For example, in a case where the immersion environment includes a cliff, and data relating to user activities in the immersion environment indicates that a user is moving about near the cliff, the immersive advertising platform 210 can determine, based on the abovementioned analyses, whether to present an advertisement object (e.g., for hiking gear or the like) proximate to the cliff, and if so, derive immersive advertising embedding data that specifies a location in the immersion environment at which the advertisement object is to be positioned, a size in which the advertisement object is to be presented, a duration for which the advertisement object is to be presented, and/or the like.

In various embodiments, the analyses and/or operations can include determining a context, location, or setting of an immersion environment and/or identifying objects (e.g., a theme of an object or the like) in an immersion environment, and deriving immersive advertising embedding data based thereon. For example, the immersive advertising platform 210 can determine a context of an immersion environment (e.g., a fishing experience) based on data relating to the immersion environment (e.g., information indicating that the XR experience relates to fishing), identify objects in the immersion environment (e.g., fishing equipment, such as a fishing rod) based on the data relating to the immersion environment (e.g., information identifying a fishing rod object), and derive immersive advertising embedding data based thereon (e.g., for embedding fishing-related advertisement object(s), such as a branded backpack, a branded fishing chair, or the like, in the immersion environment).

In various embodiments, the analyses and/or operations can include characterizing, or otherwise categorizing, advertisement possibilities based on one or more factors, such as bid price, desirability of advertisement placement opportunities, models of salience (e.g., prominences of surfaces and/or objects for advertisement placement, presumed prominences of objects native to an immersion environment relative to advertisement objects), user activity rates in spatial locations (e.g., in 360 degrees or the like) in the immersion environment, and/or object proximity considerations (e.g., proximity relating to a user, to an object within the immersion environment, to certain object classes, etc.). In some embodiments, characterization of advertisement possibilities or options may be distinct from user affinity to advertisements.

As an example, certain locations within an immersion environment, such as a waiting area in which users may be situated while awaiting other users to join the experience, may be highly desirable, or preferred, areas to place advertisements, particularly on a prominent blank wall in the waiting area. In contrast, other locations or contexts, such as an empty road in the immersion environment that associated with high activity rates (e.g., users running down the road), may be less desirable for placing advertisements. Continuing the example, the immersive advertising platform 210 can derive different immersive advertising embedding data concerning placement of advertisement objects in these various locations, such as immersive advertising embedding data operative to cause advertisement objects to be placed in more desirable locations and not (or only infrequently) in less desirable locations. As another example, in a case where data relating to an immersion environment indicates that a certain object therein is a core object of the environment, the immersive advertising platform 210 can derive immersive advertising embedding data that causes an advertisement object to be placed at or near the object, but presented in a less prominent manner relative to the core object.

In various embodiments, the analyses and/or operations can include determining and/or adjusting affinity scores (e.g., including, or based on, mathematical vectors, numerical values, and/or the like) associated with objects (e.g., objects native to an immersion environment, advertisement objects (e.g., candidate advertisement objects), etc.), user historical behavior in immersion environment(s), current user behavior in an immersion environment, candidate advertisement placement locations within an immersion environment, immersion environment characteristics (e.g., content, context, etc.), and/or the like. It is to be understood that the immersive advertising platform 210 can define affinity scores for relationships between any of foregoing items. For example, an affinity score can represent a relationship between a user and a candidate advertisement object, a relationship between a user and advertisement objects in general over time, a relationship between a candidate advertisement object and an immersion environment and/or a candidate advertisement placement location in the immersion environment, a relationship between a user and an immersion environment, and/or the like.

Affinity scores can inform (e.g., a machine learning model of the immersive advertising platform 210, an advertiser (or an agent thereof), or the like) whether to make certain decisions with regard to advertisement object(s). For example, an affinity score associated with a user and a candidate advertisement object can inform an advertiser on whether to bid, or a price to bid, to present the advertisement object to the user and/or can inform the immersive advertising platform 210 whether to embed, or otherwise include, the advertisement object in an immersion environment. As another example, an affinity score associated with a candidate advertisement object and/or a candidate advertisement placement location in an immersion environment can similarly inform an advertiser on bid decisions and/or the immersive advertising platform 210 on whether to include the advertisement object in the immersion environment. As a further example, an affinity score representative of a relationship between a user and advertisement objects in general over time can similarly inform an advertiser on bid decisions and/or the immersive advertising platform 210 on whether to include an advertisement object in an immersion environment. Continuing the example, the immersive advertising platform 210 can pause or halt embedding of advertisement objects for a user in a case where the affinity score indicates that the user has been exposed to too many advertisements in a short period of time (e.g., a quantity of advertisement objects that satisfies a threshold, which may result in ad fatigue, etc.).

In various embodiments, the analyses and/or operations can include adjusting aggregate model(s) based on user gaze within an immersion environment, such as by associating a higher affinity score, for advertisement placement, with a particular location within the immersion environment. For example, in a case where data relating to user activities and/or interactions within an immersion environment indicates that a user is gazing at a particular object or area, the immersive advertising platform 210 can associate a high affinity score for that object or area, and derive immersive advertising embedding data based on that affinity score (e.g., so as to cause an advertisement object to be positioned proximate to that object or area).

In various embodiments, the analyses and/or operations can include identifying historical user behaviors associated with certain types of immersion environments, certain types of user activities involved in immersion environments, certain types of objects, and/or the like, and determine whether an advertisement object is appropriate based thereon. For example, in a case where the context of an immersion environment includes a snowy mountainous setting, the immersive advertising platform 210 can determine, based on historical user activity data associated with such settings, that skiing- or snowboarding-related advertisements, and not sunscreen-related advertisements, would be more relevant in the immersion environment, and derive immersive advertising embedding data in accordance with such a determination. In this way, the immersive advertising platform 210 can provide an immersive advertising experience that is cohesive with an immersion environment.

In various embodiments, the analyses and/or operations can include weighing bid information relative to one or more rules concerning advertisement diversity or variety. For example, the immersive advertising platform 210 can be configured to identify any advertisement objects that are currently embedded in an immersion environment and/or any advertisement objects obtained from the ad tech system 230 (e.g., as described above with respect to reference number 256b), and determine whether a quantity of similar or same advertisement objects satisfies a threshold (e.g., is greater than or equal to the threshold) and thus violates advertisement diversity requirements. Continuing the example, the immersive advertising platform 210 may not derive immersive advertising embedding data that includes an advertisement object if including the advertisement object would result in the quantity of similar or same advertisement objects satisfying the threshold. In this way, the immersive advertising platform 210 can maintain advertisement diversity in an immersion environment despite receiving high bid prices for certain advertisement objects.

In various embodiments, the analyses and/or operations can include identifying, from user profile data, information identifying product searches conducted by a user, and obtain and process advertisement content related to such searches for embedding into an immersion environment. For example, in a case where user profile data indicates that a user recently conducted an Internet-based search for backpacks, the immersive advertising platform 210 can obtain images, videos, etc. relating to backpacks (e.g., based on a request to the ad tech system 230 for advertisers (or agents thereof) desiring to advertise such backpacks) and derive immersive advertising embedding data that includes corresponding advertisement objects. In some embodiments, the immersive advertising platform 210 can derive immersive advertising embedding data that causes the immersion engine 220 to replace an existing object (e.g., a bag or a box) in an immersion environment with an identified advertisement object (e.g., a backpack).

In various embodiments, the analyses and/or operations can include analyzing images and/or videos, included in data relating to advertisement content, for themes or contexts, and derive immersive advertising embedding data based on result(s) of the analysis. In some embodiments, the immersive advertising platform 210 can analyze data relating to advertisement content, using image or video analysis/recognition techniques or algorithms, header information (e.g., metadata) analysis techniques or algorithms, or the like, to identify explicit content (e.g., objects that correspond to explicit content, so that such objects, or an entirety of associated advertisement content, may be excluded from immersive advertising embedding data for an immersion environment), to determine an affinity between a context or theme of an immersion environment and advertisement object(s) identified in the data relating to advertisement content (e.g., where a car-related advertisement would have a high affinity to a car racing immersion experience, and thus may be excluded from immersive advertising embedding data), to determine an angle of virtual display of an advertisement object in an immersion environment and/or a distance (or proximity) of the virtual display from a user traversable path in the immersion environment (e.g., by determining sizes of objects in an image or video, contrast of the image or video, and/or the like, such that the virtual display may be presented at a suitable angle toward and/or proximity to a potential user for appropriate viewing), and/or the like.

In various embodiments, in multi-user immersion environments (e.g., massive multiplayer online environments), the analyses and/or operations can include deriving immersive advertising embedding data in a manner that accommodates multiple users in the same immersion environment. For example, the immersive advertising platform 210 can manage derivation of immersive advertising embedding data based on user profile data for some or all of the users, based on data relating to the behavior of some or all of the users in the immersion environment, based on data relating to advertisement content directed to some or all of the users, and/or the like, to provide a combined immersive advertising experience that includes a hybrid set of advertisement objects relevant to the users.

In various embodiments, in multi-user immersion environments, the analyses and/or operations can include deriving immersive advertising embedding data that enables a user to act as a promoter (e.g., a spokesperson) of advertisement object(s) (or a corresponding brand), by providing manipulation or control capabilities for the user to utilize the advertisement object (e.g., to drive a car being advertised) in the immersion environment, options for selecting one or more advertisement object(s) to promote, incentives for promoting advertisement object(s), and/or the like.

In various embodiments, the immersive advertising platform 210 can derive immersive advertising embedding data that includes instructions or commands for the immersion engine 220 to include, or otherwise embed advertisement objects, in certain system conditions or states, such as at a loading period of an immersion environment experience, during buffering of an immersion environment experience, during a pause period of an immersion environment experience, to substitute any graphical blocks that may have failed to load (e.g., due to bandwidth issues), etc. In various embodiments, the immersive advertising platform 210 can derive immersive advertising embedding data that includes instructions or commands for the immersion engine 220 to cache (or precache) advertisement objects in preparation for presentation in such system conditions or states (e.g., data-driven timing of advertisement and content placement).

As shown by reference number 260, the immersive advertising platform 210 can provide, or otherwise output, immersive advertising embedding data to the immersion engine 220, which enables the immersion engine 220 to embed advertisement object(s), or otherwise cause advertisement object(s) to be presented, in the immersion environment.

As shown by reference number 262, the immersive advertising platform 210 can obtain, from the immersion engine 220, data relating to user behavior in an immersion environment and, as shown by reference number 262a, the immersive advertising platform 210 can assess user behavior and responses to advertisement objects based thereon. The data can include information regarding user activities or interactions (e.g., including current user activities or interactions) associated with objects in the immersion environment, such as objects that are native to the immersion environment and advertisement objects presented in the immersion environment as determined by the above-described immersive advertising embedding data. The information can identify, for example, whether a user is gazing at an object, how long the user gazed at the object, how close the user was to the object during the gazing, whether the user touched, or otherwise interacted, with an object, how long the user interacted with an object, whether the user exhibited any expressions (e.g., vocal utterances) at or near an object, whether the user immediately turned away from an object after coming upon the object, whether the user ended a session in the immersion environment after coming upon an object, whether the user prefers interacting with certain types or classes of objects, whether the user prefers lingering at a certain location or in a certain area within the immersion environment, mobility of the user in the immersion environment (e.g., walking or running often in the environment), a status of a user's completion of a goal in the immersion environment (e.g., completing a task, winning a game, etc.), and/or the like.

In various embodiments, the immersive advertising platform 210 can assess user behavior and responses to advertisement objects by, for example, evaluating passive user behaviors (e.g., gazing at, turning away from, or the like from advertisement objects), evaluating active user behaviors (e.g., approaching advertisement objects, touching or otherwise interacting with advertisement objects, or the like), and/or defining representations of user behavior and interactions with advertisement objects, such as by classifying certain behaviors as corresponding to aversion of advertisement objects, certain behaviors as corresponding to affinity to advertisement objects, and/or the like. Such assessments can provide valuable information regarding user preferences with respect to various types of advertisement objects, possible user affinity to certain advertisement objects, etc.

As shown by reference number 264a, the immersive advertising platform 264a can update (e.g., in the form of feedback) user profile data and one or more models (e.g., machine learning model(s), embedding/understanding model(s), aggregate model(s), and/or the like described above) of the immersive advertising platform 210 based on result(s) of the assessment described above with respect to reference number 262a.

In various embodiments, the feedback can include information regarding explicit or implicit user behaviors with respect to an object in an immersion environment, such as an advertisement object. For example, the information can identify that a user showed interest in a certain object (e.g., that the user gazed at an advertisement object for more than a threshold period of time, that the user dwelled near an advertisement for more than a threshold period of time, that the user touched the advertisement object, or the like), averred or ignored a certain object (e.g., that the user turned away from an advertisement object within a threshold period of time after observing the advertisement object, or the like), etc. Such feedback can be leveraged in subsequent iterations of the immersive advertising platform 210 to provide an optimal immersive advertising experience for the user.

In various embodiments, the feedback can indicate to the immersive advertising platform 210 whether a decision to present an advertisement object to a user resulted in desired user behavior (e.g., user engagement with the advertisement object, such as gazing, touching, or the like for durations that satisfy corresponding thresholds, etc.), based upon which the immersive advertising platform 210 can reinforce corresponding parameter(s) that led to such a decision. As described above, the immersive advertising platform 210 can include, or be implemented in, one or more machine learning models or algorithms. The machine learning algorithm(s) can be configured to learn a user's behavior towards objects in an immersion environment, such as advertisement objects. In various embodiments, the immersive advertising platform 210 can provide information regarding such user behavior as input to the machine learning algorithm(s), which may perform machine learning to automate future determinations or predictions of future user behavior towards objects in an immersion environment. In various embodiments, the immersive advertising platform 210 can train a machine learning algorithm based on known inputs (e.g., user profile data) and known outputs (e.g., actual user behavior towards objects in an immersion environment, such as advertisement objects). The immersive advertising platform 210 can refine a machine learning algorithm based on the above-described feedback. In various embodiments, the immersive advertising platform 210 can additionally, or alternatively, refine a machine learning algorithm based on feedback from an administrator (or other user) of the immersive advertising platform 210, from one or more other devices (e.g., management device(s)), and/or the like. In various embodiments, the feedback can indicate whether immersive advertising embedding data derived by the machine learning algorithm(s) (e.g., as described above) based on new inputs, resulted in desired user behavior. When the feedback indicates that particular immersive advertising embedding data resulted in desired user behavior, the immersive advertising platform 210 can configure the machine learning algorithm(s) to derive future immersive advertising embedding data based on the particular immersive advertising embedding data (e.g., to derive immersive advertising embedding data in a manner similar to that in which the particular immersive advertising embedding data was derived). When the feedback indicates that particular immersive advertising embedding data did not result in desired user behavior, the immersive advertising platform 210 can configure the machine learning algorithm(s) to avoid deriving immersive advertising embedding data in a manner in which the particular immersive advertising embedding data was derived. In this way, the immersive advertising platform 210 can derive immersive advertising embedding data based on machine learning algorithm(s), which improves overall effectiveness of immersive advertising targeting, and conserves processor and/or storage resources that may otherwise be used to generate and store rules for deriving immersive advertising embedding data.

In various embodiments, the immersive advertising platform 210 can aggregate feedback regarding a user's behavior over time to determine long-term behavior of the user. In various embodiments, the immersive advertising platform 210 can associate a higher weight or score with long-term behavior (e.g., over multiple immersion environment experiences) relative to shorter-term behavior (e.g., one or two immersion environment experiences), and can update user profile data and/or machine learning algorithm(s) based on the relative scores. For example, in a case where aggregate feedback over a threshold period of time indicates that a user generally likes to gaze at artwork-related objects for extended durations, the immersive advertising platform 210 may put less weight on any feedback obtained from a small quantity of immersion environment experiences (e.g., one or two immersion environment experiences) where the user avoided observing artwork-related objects.

In various embodiments, the immersive advertising platform 210 can train machine learning algorithm(s) based on user behavior pertaining to all users in general. For example, if aggregate feedback concerning behavior of numerous users indicates that users generally avoid gazing, touching, or otherwise interacting with, advertisement objects that are too large (e.g., that are larger than a threshold size) too flashy, etc., the immersive advertising platform 210 can update parameters of the machine learning algorithm(s), based on such aggregate feedback, such that the machine learning algorithm(s) can derive future immersive advertising embedding data in a manner that accounts for advertisement object size, advertisement prominence, etc.

In various embodiments, the immersive advertising platform 210 can include, or be implemented in, one or more time-series machine learning models (e.g., long short-term memory (LSTM) network(s), recursive attention model(s), or the like). In some embodiments, the time-series machine learning model(s) can be configured to learn and control derivation (and/or output) of immersive advertising embedding data based on monitoring and/or modeling of a sequence of events over time. For example, the immersive advertising platform 210 can monitor a duration of a user's immersion environment experience, and determine to withhold from outputting immersive advertising embedding data to the immersion engine 220 if the duration satisfies a threshold (e.g., is less than or equal to the threshold, such as less than ten seconds, less than one minute, less than five minutes, etc.) and/or determine to output immersive advertising embedding data to the immersion engine 220 if the duration does not satisfy the threshold (e.g., is greater than or equal to the threshold). In this way, the immersive advertising platform 210 can manage immersive advertising experiences for users over time and avoid overserving or underserving the user with advertisements.

As shown by reference number 264b, the immersive advertising platform 210 can provide feedback to the ad tech system 230. In various embodiments, the feedback can include a report on some or all of the results of the assessment described above with respect to reference number 262a. This enables an advertiser associated with advertisement object(s) presented to a user in an immersion environment, for example, to determine an effectiveness of the immersive advertising and identify any adjustments that may need to be made for improved user targeting. For example, the feedback may inform an advertiser on effectiveness (or ineffectiveness) of certain advertisement object attributes, such as transparency, color, complexity, etc., whether to adjust such attributes for a specific user, a specific category of users, or for all users in general, and/or the like, which enables the advertiser to better tailor an inventory of advertisement objects for user targeting.

As shown by reference number 266, the immersive advertising platform 210 can perform domain adaptation by mapping updated data relating to user behavior and/or interactions with advertisement object(s) in an immersion environment and/or other data relating to user activities and/or interactions in the immersion environment, as input parameters (in the XR domain), to corresponding user profile data, as output parameters (in the 2D digital domain). In various embodiments, output parameters can include numerical values, mathematical vectors, and/or the like that represent affinity (e.g., an affinity between a user and an advertisement object, an affinity between a user and an object of the immersion environment, and/or the like).

In various embodiments, mapping the data from the XR domain to the 2D digital domain can include building, or otherwise compiling, an XR behavior data set, in user profile data, for a user based on the user's chosen navigational paths in XR, the user's manner of movement (e.g., gait or the like) in XR, object interactions in XR, and/or the like. In some embodiments, the immersive advertising platform 210 can leverage the XR behavior data set to identify suitable advertisement objects to include in immersive advertising for the user.

For example, where a user opts to traverse certain paths over other available paths in an immersion environment, moves around quickly and flexibly (or slowly) in an immersion environment, engages with objects (including advertisement objects) in a slow or precise manner (e.g., suggesting expertise, sophistication, attention to detail, etc.) or in a quick and/or erratic manner, gazes at or dwells about objects (including advertisement objects) for an extended (or a short) period of time, and/or the like, the immersive advertising platform 210 can store corresponding data in the user's profile data reflecting the user's behavior, which the immersive advertising platform 210 can utilize (e.g., in a future immersion environment experience) to provide an immersive advertising experience for the user that comports or aligns with the user's preferences and/or behavior. Continuing the example, in a case where the XR behavior data set indicates that a user tends to traverse a navigational path with certain features (e.g., a path along a coastline), the immersive advertising platform 210 may position advertisement objects at locations along the same or similar navigational paths, and not at locations in other available paths. Further continuing the example, in a case where the XR behavior data set indicates that a user moves around very quickly in an immersion environment, the immersive advertising platform 210 may target the user with advertisement objects relating to sports equipment, such as running shoes or the like. Still continuing the example, in a case where the XR behavior data set indicates that a user engages with objects in a slow, precise, or investigational manner, the immersive advertising platform 210 may present additional levels of information associated with an advertisement object, such as technical specifications or the like, and/or may enable enhanced control or manipulation of the advertisement object by the user, such as enabling more degrees of rotation or orienting of the advertisement object, raising of the advertisement object, carrying of the advertisement object about in the immersion environment, wearing the advertisement object, and/or the like.

Mapping the data from the XR domain to the 2D digital domain, as described herein, can also facilitate ease of A/B testing for improved immersive advertising effectiveness, including, for example enabling determinations of whether certain advertisement objects (e.g., billboard-type advertisement objects versus advertisement objects that resemble actual corresponding branded products, etc.) are more effective at driving certain user behaviors.

In this way, user profile data relating to a user can (e.g., continuously be updated to) reflect the user's behavior in XR, including with respect to advertisement objects, which can enable subsequent iterations of the immersive advertising platform 210 to provide an optimal immersive advertising experience for the user.

In various embodiments, and in a case where there is minimal to no available data for a user, such as data relating to the user's behavior in immersion environment(s), the immersive advertising platform 210 can generate, or utilize, a pre-trained, baseline model for deriving immersive advertising embedding data for the user. The baseline model can be based on behavior models associated with one or more other users (e.g., of a demographic similar to that of the user, who have entered a similar immersion environment as that which the user is currently experiencing, etc.), including data relating to other users' behavior in immersion environment(s), and/or the like, and can serve as a cold start for the user. As the user performs actions in one or more immersion environments, and the immersive advertising platform 210 obtains data relating to such actions from the immersion engine 220, the immersive advertising platform 210 can update the user's user profile data and the behavior model of the user (e.g., in a manner similar to that described above with respect to reference number 264a).

In various embodiments, the immersive advertising platform 210 can include, or otherwise, be integrated with the immersion engine 220. For example, the immersive advertising platform 210 and the immersion engine 220 can be implemented in a common server device and/or device(s). Integration of the immersive advertising platform 210 and the immersion engine 220 in this manner enables rapid and dynamic provision of immersive advertising in an immersion environment, including fine-tuning of vectors and/or other data representative of different user behaviors in an immersion environment, representative of advertisement relevancy in different immersion environment contexts, and/or the like in real-time, or near real-time.

In various embodiments, the immersive advertising platform 210 and the immersion engine 220 can alternatively be separately implemented (e.g., implemented in a different server device or device(s)), but may be communicatively coupled to one another to exchange immersion environment-related and/or user behavior-related data.

In various embodiments, the immersive advertising platform 210, as described herein, can deliver dynamic immersive advertising to users in real-time (or near real-time), while the users are engaged in XR experiences. In some embodiments, the immersive advertising platform 210 can additionally, or alternatively, preload an inventory of advertisement objects to the immersion engine 220, such as in cases where there is limited network (e.g., cellular network) coverage at a user's current location.

In various embodiments, the immersive advertising platform 210 can provide a guided capability for advertisers to leverage the immersive advertising platform 210 via external inputs. For example, in some embodiments, the immersive advertising platform 210 can include an interface (e.g., operable via one or more languages and/or syntaxes) that enables an advertiser to input advertisement object, or advertising campaign, attributes or parameters (e.g., relating to advertisement object opacity, transparency, color, audio, graphical representation, degrees of freedom thereof (e.g., where a certain color must be an exact shade or color or where slight differences in color are acceptable), etc.). In various embodiments, the interface can be implemented in the immersive advertising platform 210, or alternatively, in one or more separate devices communicatively coupled to the ad tech system 230 and the immersive advertising platform 210.

It is to be understood and appreciated that, although reference numbers 250 to 266 pertaining to various processes and/or actions, are described herein in a particular order, some of these processes and/or actions may occur in different orders and/or concurrently with other processes and/or actions from what is depicted and described herein. Moreover, not all of these processes and/or actions may be required to implement the systems and/or methods described herein.

Although FIG. 2A shows a single immersive advertising platform 210, a single immersion engine 220, and a single ad tech system 230, in practice, there can be hundreds, thousands, millions, billions, etc. of such platforms, systems, and engines. In this way, example system 200 can coordinate, or operate in conjunction with, a set of devices and/or operate on data sets that cannot be managed manually or objectively by a human actor.

FIG. 2B is a block diagram illustrating an example, non-limiting embodiment of a system 270 functioning in, or in conjunction with, the communication network 100 of FIG. 1 and/or the system 200 of FIG. 2A in accordance with various aspects described herein. In various embodiments, the system 270 can correspond to, include, or be included in, the system 200 of FIG. 2A.

As shown in FIG. 2B, the system 270 can include machine learning model(s) 272 (e.g., domain adaptation model(s), transfer learning model(s), embedding/understanding model(s), time-series machine learning model(s) (e.g., long short-term memory (LSTM) network(s), recursive attention model(s), etc.), and/or the like) having multiple memory cells 274. In various embodiments, the machine learning model(s) 272 can be trainable and configured to output predictions of optimal advertisement inventories for embedding into immersion environments. The machine learning model(s) 272 can (e.g., similar to that described above with respect to the immersive advertising platform 210) input user profile data (e.g., information concerning user preferences, advertisement responses, etc.), perform mapping of the user profile data into the XR realm, input advertisement content (e.g., including formatting requirements), input data relating to immersion environment(s) (e.g., object information, location information, etc.) as well as data relating to user activities and/or interactions in immersion environment(s), input historical prediction data, and output predictions of optimal advertisement objects for embedding into immersion environments (e.g., embedded user context) and/or inventories based on parameters of the machine learning model(s) 272. As an example, the predictions can include, or otherwise correspond to, the immersive advertising embedding data described above with respect to reference number 258 of FIG. 2A.

FIG. 2C is a diagram illustrating an example progression 280 of immersive advertising enabled by the communication network 100 of FIG. 1, the system 200 of FIG. 2A, and/or the system 270 of FIG. 2B in accordance with various aspects described herein. As shown in FIG. 2C, a user 281 may be experiencing a fishing immersion environment 282, where advertisement content from an inventory of advertisement content 283 (e.g., images, text, audio clips, etc.) may be identified as immersive advertising inventory 284, which may be embedded, as corresponding advertisement objects, into the fishing immersion environment 282 (e.g., in a manner similar to that described above with respect to the immersive advertising platform 210 of FIG. 2A) to provide an immersive advertising experience for the user 281.

FIG. 2D depicts an illustrative embodiment of a method 290 in accordance with various aspects described herein. In some embodiments, one or more process blocks of FIG. 2D can be performed by an immersive advertising platform, such as the immersive advertising platform 210. In some embodiments, one or more process blocks of FIG. 2D may be performed by another device or a group of devices separate from or including the immersive advertising platform 210, such as the immersion engine 220 and/or the ad tech system 230.

At 291, the method can include obtaining data relating to a user, where the data relating to the user includes user profile data regarding user activities in a first domain. For example, the immersive advertising platform 210 can obtain data relating to a user in a manner similar to that described above with respect to the system 200 of FIG. 2A, where the data relating to the user includes user profile data regarding user activities in a first domain (e.g., a 2D digital domain).

At 292, the method can include mapping the user profile data to a second domain, resulting in mapped user profile data. For example, the immersive advertising platform 210 can map the user profile data to a second domain, resulting in mapped user profile data in a manner similar to that described above with respect to the system 200 of FIG. 2A.

At 293, the method can include receiving, from an immersion engine, data regarding an immersion environment. For example, the immersive advertising platform 210 can receiving, from the immersion engine 220, data regarding an immersion environment in a manner similar to that described above with respect to the system 200 of FIG. 2A.

At 294, the method can include obtaining data relating to advertisement content, where the data relating to advertisement content includes information identifying an advertisement object. For example, the immersive advertising platform 210 can obtain data relating to advertisement content in a manner similar to that described above with respect to the system 200 of FIG. 2A, where the data relating to advertisement content includes information identifying an advertisement object.

At 295, the method can include deriving immersive advertising data based on the mapped user profile data, the data regarding the immersion environment, and the data relating to the advertisement content. For example, the immersive advertising platform 210 can derive immersive advertising data based on the mapped user profile data, the data regarding the immersion environment, and the data relating to the advertisement content in a manner similar to that described above with respect to the system 200 of FIG. 2A.

At 296, the method can include outputting the immersive advertising data to the immersion engine, where the immersive advertising data enables the immersion engine to embed the advertisement object in the immersion environment. For example, the immersive advertising platform 210 can output the immersive advertising data to the immersion engine 220 in a manner similar to that described above with respect to the system 200 of FIG. 2A, where the immersive advertising data enables the immersion engine 220 to embed the advertisement object in the immersion environment.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

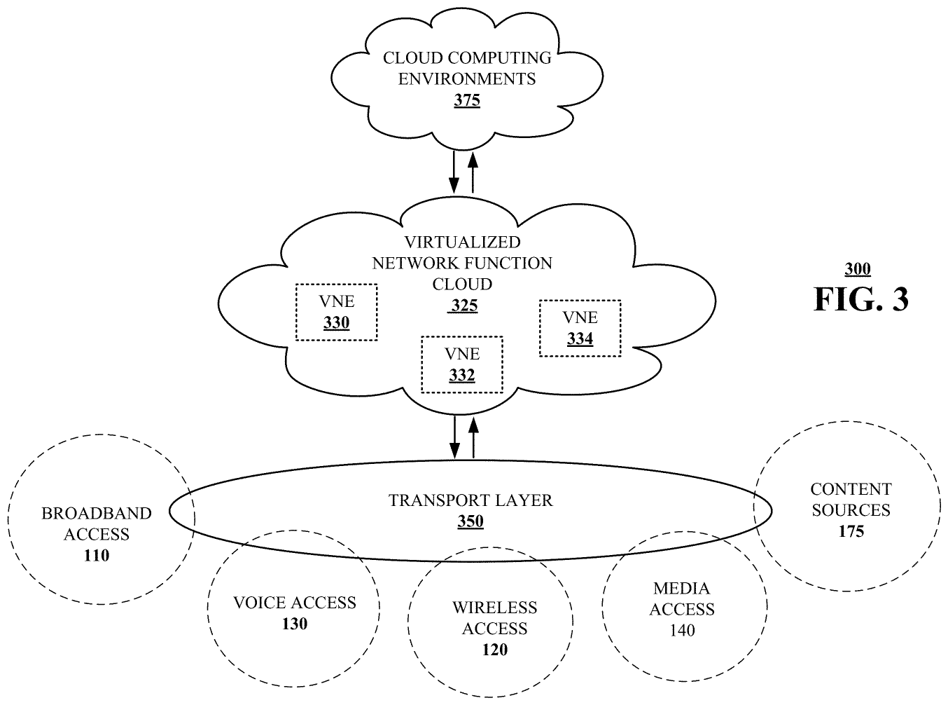

Referring now to FIG. 3, a block diagram 300 is shown illustrating an example, non-limiting embodiment of a virtualized communication network in accordance with various aspects described herein. In particular, a virtualized communication network is presented that can be used to implement some or all of the subsystems and functions of system 100, the subsystems and functions of system 200 and/or system 270, and method 290 presented in FIGS. 1, 2A, 2B, and 2D. For example, virtualized communication network 300 can facilitate in whole or in part personalization, or optimization, of immersive advertising in an immersion environment based on user profile data (e.g., including data relating to user activities and/or preferences in the digital domain, data relating to user behavior within immersion environment(s), and/or the like), data relating to an immersion environment, and/or data relating advertisement content (e.g., information identifying candidate advertisement objects for inclusion in the immersion environment).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

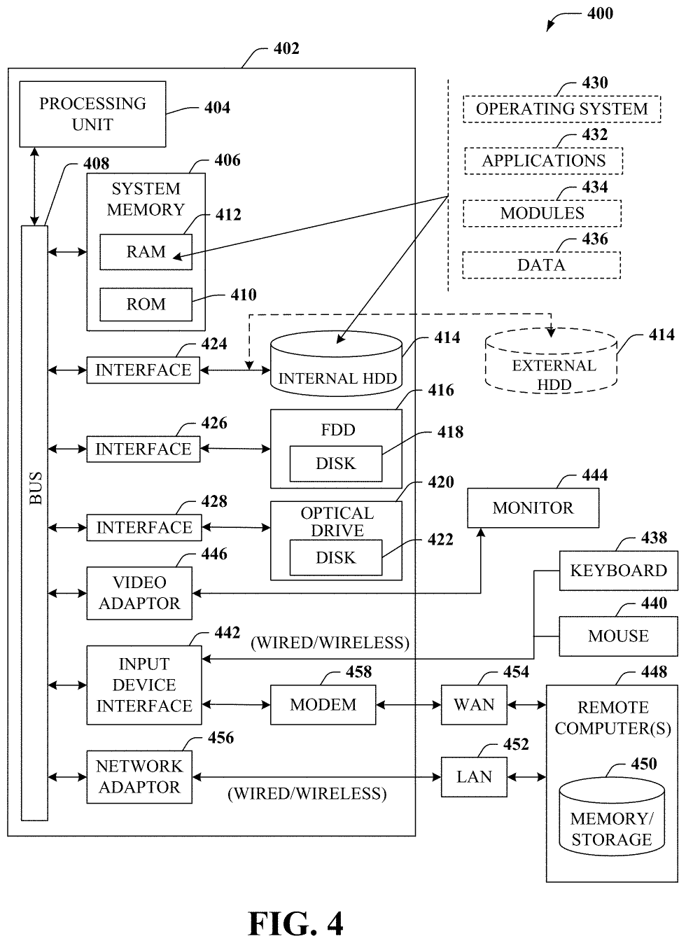

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part personalization, or optimization, of immersive advertising in an immersion environment based on user profile data (e.g., including data relating to user activities and/or preferences in the digital domain, data relating to user behavior within immersion environment(s), and/or the like), data relating to an immersion environment, and/or data relating advertisement content (e.g., information identifying candidate advertisement objects for inclusion in the immersion environment).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

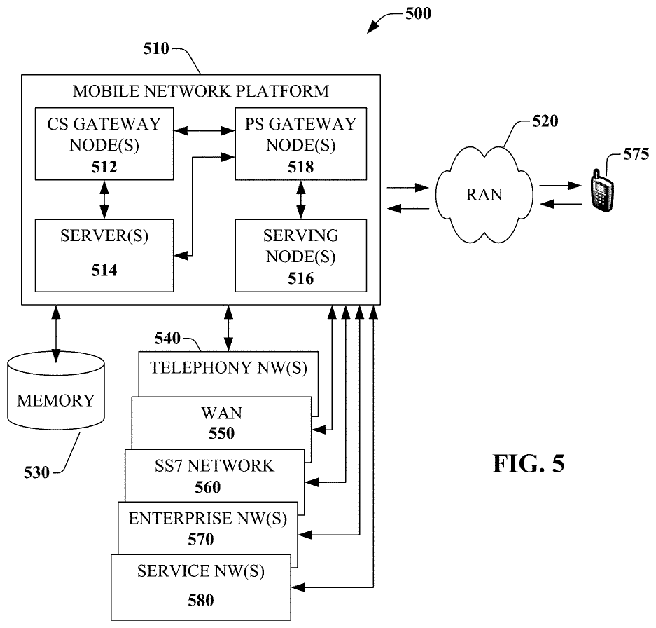

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part personalization, or optimization, of immersive advertising in an immersion environment based on user profile data (e.g., including data relating to user activities and/or preferences in the digital domain, data relating to user behavior within immersion environment(s), and/or the like), data relating to an immersion environment, and/or data relating advertisement content (e.g., information identifying candidate advertisement objects for inclusion in the immersion environment). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1 that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

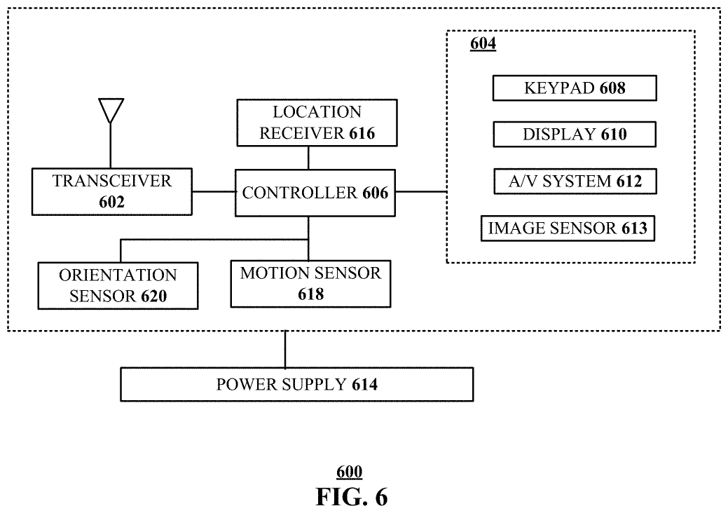

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part personalization, or optimization, of immersive advertising in an immersion environment based on user profile data (e.g., including data relating to user activities and/or preferences in the digital domain, data relating to user behavior within immersion environment(s), and/or the like), data relating to an immersion environment, and/or data relating advertisement content (e.g., information identifying candidate advertisement objects for inclusion in the immersion environment).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining data relating to a user, wherein the data relating to the user includes user profile data regarding user activities in a first domain;
mapping the user profile data to a second domain, resulting in mapped user profile data;
receiving, from an immersion engine, data regarding an immersion environment;
obtaining data relating to advertisement content, wherein the data relating to advertisement content includes information identifying an advertisement object;
deriving immersive advertising data based on the mapped user profile data, the data regarding the immersion environment, and the data relating to the advertisement content; and
outputting the immersive advertising data to the immersion engine, wherein the immersive advertising data enables the immersion engine to embed the advertisement object in the immersion environment.

2. The device of claim 1, wherein the deriving the immersive advertising data comprises determining an affinity between the user and the advertisement object based on the mapped user profile data and the data relating the advertisement content, and selecting the advertisement object for embedding in the immersion environment based on the affinity between the user and the advertisement object.

3. The device of claim 1, wherein the deriving the immersive advertising data comprises determining an affinity between the advertisement object and the immersion environment based on the data relating to the advertisement content and the data regarding the immersion environment, and selecting the advertisement object for embedding in the immersion environment based on the affinity between the advertisement object and the immersion environment.

4. The device of claim 1, wherein the mapping the user profile data to the second domain comprises processing the user profile data via domain adaptation.

5. The device of claim 1, wherein the processing system includes a machine learning model.

6. The device of claim 1, wherein the obtaining the data relating to advertisement content comprises obtaining the data relating to advertisement content from an ad tech system.

7. The device of claim 6, wherein the operations further comprise transmitting a portion of the user profile data to the ad tech system, and wherein the obtaining the data relating to the advertisement content is responsive to the transmitting the portion of the user profile data to the ad tech system.

8. The device of claim 1, wherein the first domain comprises a two-dimensional (2D) digital domain, and wherein the second domain comprises an extended reality (XR) domain.

9. The device of claim 1, wherein the immersion environment is provided via an extended reality (XR) system.

10. The device of claim 1, wherein the data regarding the immersion environment includes information regarding a context of the immersion environment, information regarding an object included in the immersion environment, data regarding a behavior of the user in the immersion environment, or a combination thereof.

11. A non-transitory machine-readable medium, comprising executable instructions that, when executed by a processing system including a processor, facilitate performance of operations, the operations comprising:
receiving, from an immersive advertising platform, data relating to a user and data regarding an immersion environment;
providing, to the immersive advertising platform and responsive to the receiving the data relating to the user and the data regarding the immersion environment, data relating to advertisement content, wherein the data relating to advertisement content includes information identifying an advertisement object and bid information, and wherein the information identifying the advertisement object and the bid information enable the immersive advertising platform to derive immersive advertising data capable of causing an immersion engine to embed the advertisement object in the immersion environment;
obtaining, from the immersive advertising platform, feedback regarding a behavior of the user relative to the advertisement object; and
modifying the data relating to the advertisement content based on the feedback, resulting in modified data, wherein the modified data is usable to cause the immersive advertising platform to derive different immersive advertising data for the user in the immersion environment or in a different immersion environment.

12. The non-transitory machine-readable medium of claim 11, wherein the information identifying the advertisement object and the bid information enable the immersive advertising platform to identify an ad inventory for an immersive domain, and wherein the modifying the data relating to the advertisement content comprises adjusting an attribute of the advertisement object.

13. The non-transitory machine-readable medium of claim 11, wherein the data relating to the user includes user profile data regarding user activities associated with a two-dimensional (2D) digital domain.

14. The non-transitory machine-readable medium of claim 11, wherein the obtaining the feedback regarding the behavior of the user relative to the advertisement object comprises obtaining the feedback while the user is experiencing the immersion environment.

15. The non-transitory machine-readable medium of claim 11, wherein the advertisement object comprises an image, text, an audio clip, a video clip, or a combination thereof.

16. A method, comprising:
providing, by a processing system including a processor, and to an immersive advertising platform, data regarding an immersion environment, wherein the data regarding the immersion environment includes information identifying a plurality of locations in the immersion environment that is available for placement of an advertisement, and wherein the data regarding the immersion environment enables the immersive advertising platform to derive immersive advertising data for advertisement embedding into the immersion environment;
obtaining, by the processing system, from the immersive advertising platform and responsive to the providing the data regarding the immersion environment to the immersive advertising platform, the immersive advertising data, wherein the immersive advertising data identifies an advertisement object and identifies a location of the plurality of locations in the immersion environment at which the advertisement object is to be positioned;
presenting, by the processing system, the advertisement object at the location of the plurality of locations in the immersion environment responsive to the obtaining the immersive advertising data from the immersive advertising platform;
detecting, by the processing system, an interaction, by a user, with the advertisement object at the location of the plurality of locations in the immersion environment; and
causing, by the processing system, data regarding the interaction to be transmitted to the immersive advertising platform responsive to the detecting the interaction.

17. The method of claim 16, wherein the processing system includes an extended reality (XR) immersion engine.

18. The method of claim 17, wherein the immersion engine is integrated with the immersive advertising platform.

19. The method of claim 16, wherein the data regarding the immersion environment includes information identifying a context of the immersion environment.

20. The method of claim 16, wherein the data regarding the interaction enables the immersive advertising platform to update user profile data corresponding to the user.
